(19) United States
(12) Patent Application Publication
(10) Pub. No.: US 2008/0071683 A1
(43) Pub. Date: Mar. 20, 2008

(54) RETURN FEE SYSTEM FOR ELECTRONIC CHECK ACCEPTANCE

(75) Inventors: Wanda Hayden, Houston, TX (US); Anne Cusimano, Houston, TX (US); Chris Schmid, Houston, TX (US); Previn V. Sagar, Pearland, TX (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: First Data Corporation, Greenwood Village, CO (US)

(21) Appl. No.: 11/857,302

(22) Filed: Sep. 18, 2007

Related U.S. Application Data
(60) Provisional application No. 60/846,041, filed on Sep. 19, 2006.

(51) Int. Cl. G06Q 40/00

(52) U.S. Cl. 705/45

(57) ABSTRACT

A check acceptance method for transmitting the check return fee information that applies to a check submitted by a customer. A host computer can transmit for use by a client computer the return fee that will apply to a transaction if a check is returned for insufficient funds. In addition, a return fee note field can be used to transmit explanatory notes that are used to explain non-flat fee charges that will apply.

### CROSS-REFERENCES TO RELATED APPLICATIONS

The present application claims the benefit under 35 U.S.C. §119(e) of U.S. Patent Application 60/846,041, filed Sep. 19, 2006, entitled “RETURN FEE SYSTEM FOR ELECTRONIC CHECK ACCEPTANCE” which is hereby incorporated by reference in its entirety as if fully set forth herein for all purposes.

### STATEMENT AS TO RIGHTS TO INVENTIONS MADE UNDER FEDERALLY SPONSORED RESEARCH OR DEVELOPMENT

NOT APPLICABLE

### REFERENCE TO A “SEQUENCE LISTING,” A TABLE, OR A COMPUTER PROGRAM LISTING APPENDIX SUBMITTED ON A COMPACT DISK

NOT APPLICABLE

### BACKGROUND

In the past, electronic check acceptance (ECA) which is also known as point of purchase check conversion (POP) has operated by providing the customer who is paying by check with a receipt that states that the fee to be charged to the customer will be some fixed fee or “an applicable amount allowable by law.” However, there was no way for a processing system to tailor the fee to individual states or governmental bodies that regulated financial transactions. There was no way to take into account different fees that could be charged by a merchant depending upon where a particular point of purchase was located, the amount of the transaction, or the amount of time that a check went unpaid after it was returned for insufficient funds. Thus, there has been a need for a system that allows an electronic check processor to report the actual amount that will be charged for a returned check.

Similarly, it has not been possible in the past to communicate additional details about the additional fees charged when a check is rejected for non-sufficient funds. Thus, this too has been a problem for merchants located in states that have more detailed and complicated calculations for returned check fees.

In addition, since some merchants stated a fixed returned check fee, it has been difficult for a collection system at a host computer to know what that fixed fee is. This has made it difficult for the collection system to try and collect the same fee that the consumer was told would be charged. Rather, the collection system has instead had to collect the minimum fee allowable so as to avoid any possibility of collecting more than the customer was told would be collected as a returned check fee.

Consequently, there is a need for a system that addresses these drawbacks in earlier systems and provides a solution to at least one of these deficiencies.

### SUMMARY

In accordance with one embodiment of the invention, a check acceptance system can be implemented that comprises configuring a host computer for transmitting a check acceptance message from the host computer to a client computer; and transmitting from the host computer for use by the client computer the check acceptance message comprising a return fee field.

In accordance with another embodiment of the invention, a check acceptance system can be implemented that comprises configuring a host computer for transmitting a return fee message from the host computer to a client computer; and transmitting from the host computer for use by the client computer the check acceptance message comprising a return fee notes field.

In accordance with another embodiment of the invention, a check acceptance system can be implemented by providing a check authorization system; coupling a return fee database with the check authorization system; receiving at the check authorization system a check authorization request for a check instrument; utilizing the return fee database to determine a return fee for the check instrument; and outputting the return fee for use by a merchant in printing a receipt.

### BRIEF DESCRIPTION OF THE DRAWINGS

FIG. 1 illustrates a block diagram that illustrates an electronic check processing system for use with at least one embodiment of the invention.

FIG. 2 illustrates a block diagram that illustrates a check authorization process that can be utilized with at least one embodiment of the invention.

FIG. 3 illustrates a block diagram of an electronic check processing system in accordance with one embodiment of the invention.

FIG. 4 illustrates a host system for use with at least one embodiment of the invention.

FIG. 5 illustrates a block diagram of a computing device that can be used in accordance with at least one embodiment of the invention.

FIGS. 6A, 6B, 6C, 6D, and 6E illustrate different transmission formats that can be used with various embodiments of the invention.

FIG. 7 illustrates a flow chart demonstrating a method of check processing in accordance with one embodiment of the invention.

FIGS. 8A and 8B illustrate a flow chart demonstrating a method of check processing in accordance with one embodiment of the invention.

FIG. 9 illustrates a flow chart demonstrating a method of check processing in accordance with one embodiment of the invention.

FIGS. 10A and 10B illustrate a flow chart demonstrating a method of check processing in accordance with one embodiment of the invention.

FIG. 11 illustrates an example of a receipt that can be used to notify a consumer of a return fee amount and notes to explain the return fee amount.

FIG. 12 illustrates a block diagram of a electronic check authorization system in accordance with one embodiment of the invention.

FIG. 13 illustrates a flow chart demonstrating a method of determining a return fee for a check instrument in accordance with one embodiment of the invention.

FIGS. 14A, 14B and 14C illustrate a flow chart demonstrating a method of determining a return fee in accordance with one embodiment of the invention.

FIGS. 15A, 15B, and 15C illustrate a flow chart demonstrating a method of determining a return fee in accordance with one embodiment of the invention.

### DETAILED DESCRIPTION

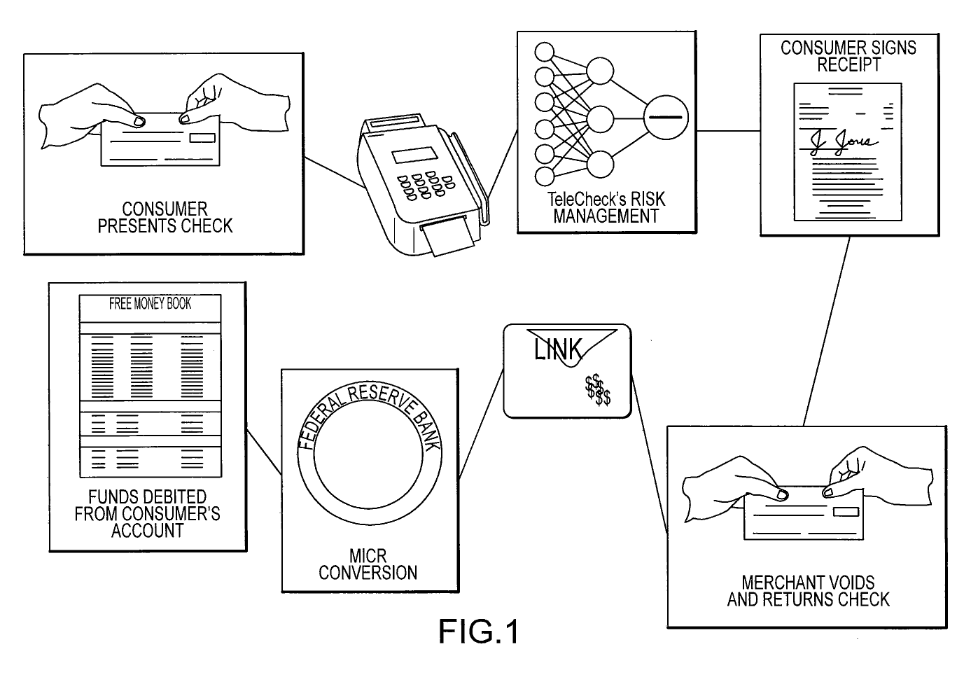

An example of an electronic check acceptance system, which is also commonly referred to as point of purchase check conversion, is shown in accordance with the overview diagram shown in FIG. 1. In FIG. 1, a consumer presents a check to a merchant at a point of purchase location. The merchant uses an electronic check reader to capture the check information. This information can then be routed to a risk management check authorization system, such as the check authorization system of Telecheck Services, Inc. of Houston, Tex. Upon approval of the check by the check authorization system, a consumer can sign a receipt for the purchase acknowledging the terms of collection if the check is later rejected for non-sufficient funds. In the past, the terms have recited a fixed fee that was stored at the merchant's terminal or merely recited that the return fee (also commonly referred to as the non-sufficient funds (NSF) fee) would be the maximum allowable by law. The receipt is returned to the merchant and a copy is also made available to the consumer. Furthermore, since the merchant has captured the check information via the check reader, the physical check is stamped VOID and returned at the time of sale to the consumer by the merchant. In some instances, the check authorization system might instruct the merchant to retain the physical copy of the check. The captured check (or physical check) can then be processed (e.g., through image exchange, check conversion, or traditional paper exchange) and funds can be settled so that the amount of the check is debited from the consumer's account and credited to the merchant's account. For example, the check can be converted to an Automated Clearing House transaction and processed as a debit from the consumer's checking account.

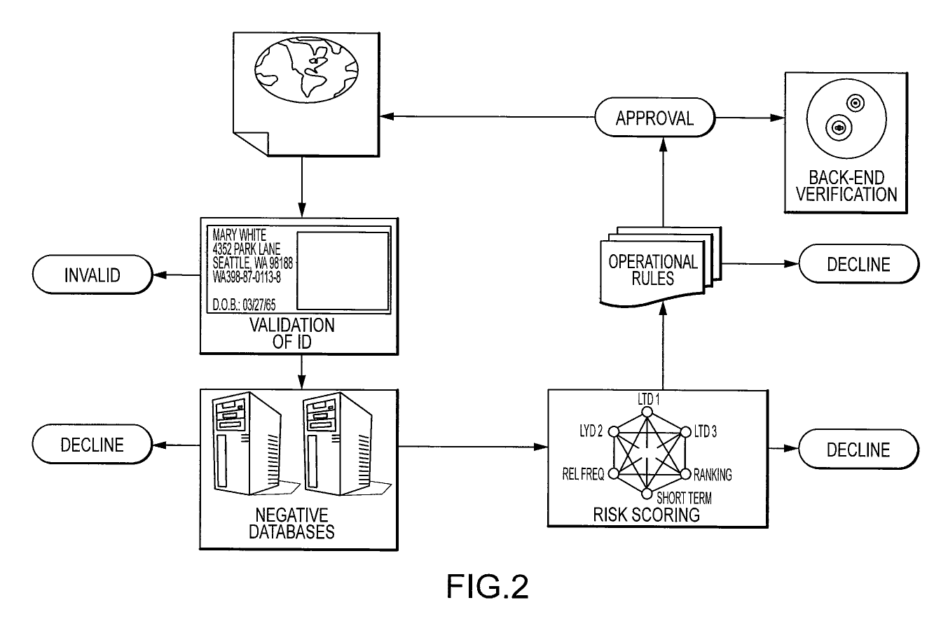

Authorization of a check can be performed according to a variety of mechanisms. FIG. 2 illustrates an example of one such system. Namely, in FIG. 2, a check is first presented. The identification of the person presenting the check can first be checked by the cashier to confirm that the name on the check matches the identity of the person presenting the check. Then the check information can be compared to a negative database to determine whether the customer has a history of submitting bad checks. If that test is not satisfied within predetermined parameters, the authorization can be declined. Next, a risk scoring model can be used to assess the risk of accepting the check. Again, such models can vary by different processing entities. Next, operational rules can be applied. Assuming all of the tests are met, the check can be approved, as shown in FIG. 2. However, if the authorization process just barely passes the approval process, a back-end verification procedure can be performed where further authorization is performed in the time period immediately following authorization.

In the past, a receipt was issued as part of the electronic check authorization process so as to indicate to the consumer the return fee to be applied for a bad check. The return fee was generated from information stored at the terminal where the check was presented. This was typically done by noting on the receipt a fixed amount that would satisfy the regulations of the state where the transaction took place or by stating that the check return fee that would be applied would be the maximum amount permitted by law. There was not a mechanism to tailor the fee dynamically for a particular location as regulations changed, for a particular amount, nor for a particular time period after purchase.

It is worth noting that the return fees charged for non-sufficient funds vary from state to state. The fees are also often amended with new fees taking effect throughout the course of a year. As another example, some states apply a check return fee that varies depending on the amount of the transaction. Thus, each transaction may result in a different return fee being applicable. Furthermore, some states apply a fee that varies over time after a check is declined for non-sufficient funds. Thus, the return fee will increase with time if it is not paid on time. Thus, it is difficult for an electronic check processor to constantly update the terminals where checks are accepted with the current fees for a particular state. This is particularly true of standalone terminals that require the user of the terminal to manually dial in and download an updated fee amount. The owner of the store where the terminal is located typically has other tasks to perform that cause the owner to fall behind in updating this information. Consequently, there is the possibility that the owner could inadvertently start issuing receipts that state the wrong fee.

This dilemma can be overcome in accordance with one embodiment of the invention by providing the check return fee information via a database that is accessible via the check processing host. This allows the check processing host to constantly update the relevant fee information and notify the terminal of the correct fee with each transaction. Thus, this system removes the possibility of error in reporting an incorrect check return fee to the customer via the receipt.

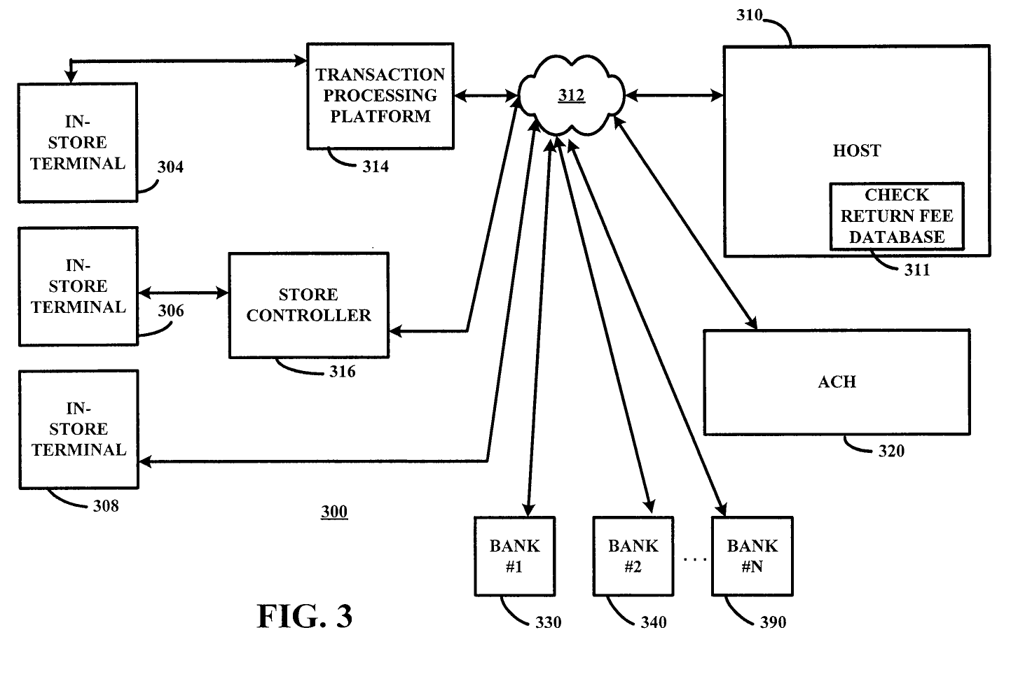

FIG. 3 illustrates a block diagram of a system for implementing a check return fee system in accordance with one embodiment of the invention. FIG. 3 shows a system 300 in which a host 310 is in electronic communication with other elements of the system across a network 312. The host 310 is shown in communication with a check return fee database 311. The check return fee database can be located separately from the host; but, it is shown as part of the host in FIG. 3. Different in-store terminals are coupled to the host in a variety of manners. For example, in-store terminal 308 is shown coupled directly to the network 312 for communication with the host. In such a system where dial up connections are used, the communication system could be a dial up line to the host via the publicly switched telephone network (PSTN). Alternatively, the communication could be via encrypted communications across an open network such as the internet. Similarly, FIG. 3 shows that an in-store controller 316 can serve as an interface between the in-store terminal and the host. Moreover, an intermediate transaction processing platform can serve as an intermediary between a store and the host. For example, FIG. 3 shows a transaction processing platform 314 that receives electronic transactions and routes them to the host from in-store terminal 304. In such an instance, a transaction fee would be paid for the services of the transaction processing platform.

Once a check is accepted by the host, the transaction can be settled by routing the transaction to the Automated Clearing House (ACH) 320. Furthermore, the ACH can then debit the funds from the consumer's bank, such as Bank #1 330 and credit the funds to the merchant's bank, such as Bank #2 340. A variety of banks can be coupled with the ACH system as indicated by Bank #N 390.

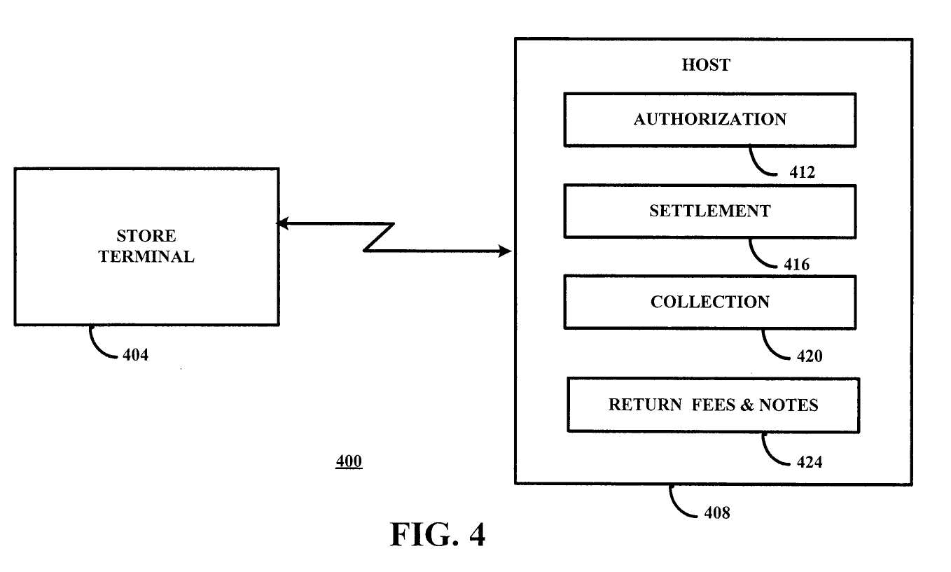

FIG. 4 illustrates an exemplary embodiment of a host check processor in a check acceptance system 400. Namely, FIG. 4 shows a store terminal 404 or client computer coupled electronically with a host system 408. The host is comprised of an authorization system 412 for authorizing a check; a settlement system 416 for settling funds after a transaction is completed; and a collection system 420 for collecting return fees and unpaid amounts when non-sufficient funds are present. A Return Fees and Notes database 424 is shown as part of the host system as well. Each of these systems could be part of a combined host system or merely accessible via the host system.

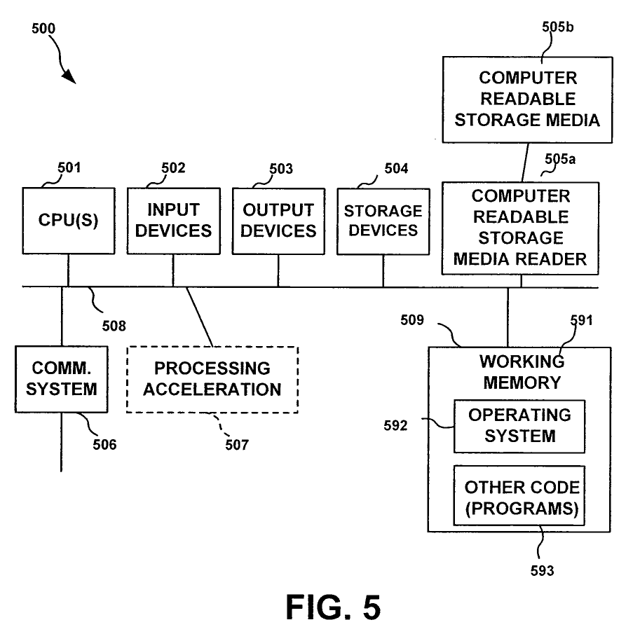

The components of FIGS. 3 and 4 can be implemented in accordance with the device shown in FIG. 5. FIG. 5 broadly illustrates how individual system elements can be implemented. System 500 is shown comprised of hardware elements that are electrically coupled via bus 508, including a processor 501, input device 502, output device 503, storage device 504, computer-readable storage media reader 505a, communications system 506 processing acceleration (e.g., DSP or special-purpose processors) 507 and memory 509. Computer-readable storage media reader 505a is further coupled to computer-readable storage media 505b, the combination comprehensively representing remote, local, fixed and/or removable storage devices plus storage media, memory, etc. for temporarily and/or more permanently containing computer-readable information, which can include storage device 504, memory 509 and/or any other such accessible system 500 resource. System 500 also comprises software elements (shown as being currently located within working memory 591) including an operating system 592 and other code 593, such as programs, applets, data and the like.

System 500 has extensive flexibility and configurability. Thus, for example, a single architecture might be utilized to implement one or more servers that can be further configured in accordance with currently desirable protocols, protocol variations, extensions, etc. However, it will be apparent to those skilled in the art that embodiments may well be utilized in accordance with more specific application requirements. For example, one or more system elements might be implemented as sub-elements within a system 500 component (e.g. within communications system 506). Customized hardware might also be utilized and/or particular elements might be implemented in hardware, software (including so-called “portable software,” such as applets) or both. Further, while connection to other computing devices such as network input/output devices (not shown) may be employed, it is to be understood that wired, wireless, modem and/or other connection or connections to other computing devices might also be utilized. Distributed processing, multiple site viewing, information forwarding, collaboration, remote information retrieval and merging, and related capabilities are each contemplated. Operating system utilization will also vary depending on the particular host devices and/or process types (e.g. computer, appliance, portable device, etc.) Not all system 500 components will necessarily be required in all cases.

Referring again to FIG. 4, an exemplary check acceptance transaction can be illustrated in accordance with one embodiment of the invention. Upon completion of totaling up the cost for the goods being purchased by a consumer, a merchant at store terminal 404 can send a request message to the host 408. The check approval request includes the amount of the transaction and the state where the terminal is located. This allows the host to determine the return fee that would apply for a particular state based on the amount of the check amount, if the state is one that determines the return fee based upon the amount of the transaction. Since different states or governmental entities will apply different return fees, the location of the terminal is needed to determine the return fee that will apply. Once the host receives the request, the authorization tests can be performed by the authorization module 412 and the applicable return fees and notes can be obtained from database 424. If the check is rejected, an appropriate return signal can be sent back to the terminal. If the check is accepted, a positive signal check acceptance signal can be communicated to the store terminal. Furthermore, the amount of the return fee that should be listed on the receipt can be supplied as part of the message from the host to the store terminal. In addition, for states that require additional information, a return fee notes field can be returned from the host to the store terminal. Additional information can be returned, as well, as will be explained below.

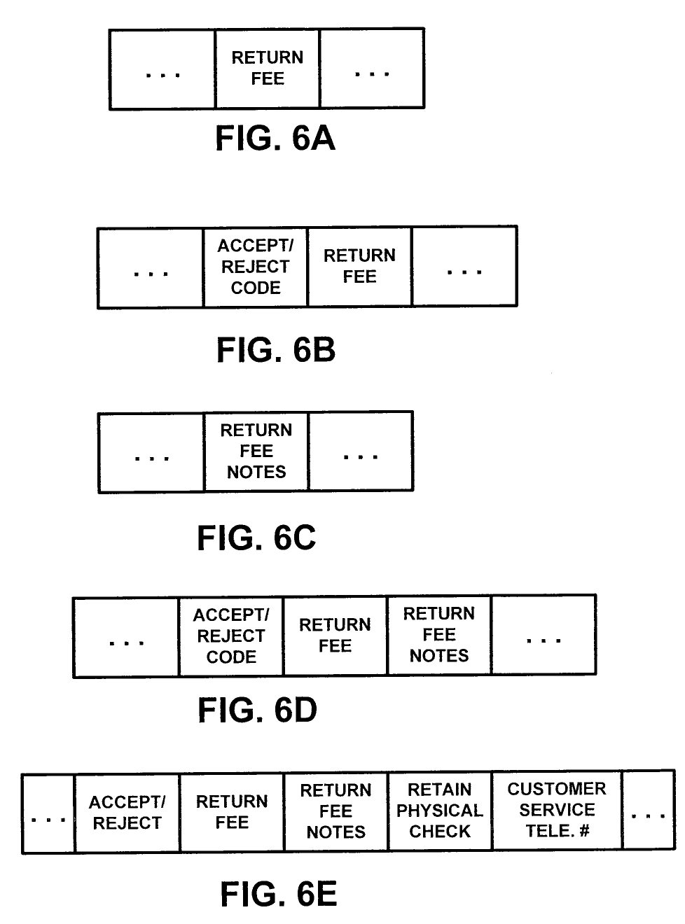

FIGS. 6A, 6B, 6C, 6D, and 6E illustrate examples of different formats for data messages that can be returned to the store terminal from the host. For example, if a check is accepted, the host can communicate to the store terminal a message that comprises the check return fee, as shown in FIG. 6A. Similarly, the check return fee can be part of a transmission that also includes an Accept/Reject code for whether to accept the check in the first place. An example of this message is shown in FIG. 6B.

Similarly, in states that require additional check return information to be placed on a receipt or that involve a more complicated check return fee calculations, a check return fee notes message can be communicated to the store terminal via the host. FIG. 6C illustrates this message format. The check return fee notes section can be combined with the check return fee message and/or the Accept/Reject Code message as shown in FIG. 6D. This allows the host to communicate whether a check will be accepted, the check return fee to be printed on the receipt, and the notes to accompany the check return fee on the receipt.

Additional information can also be conveyed from the host computer to the store terminal in accordance with other embodiments of the invention. For example, in some instances the host may want tot direct the merchant to retain the physical check instrument rather than return it to the consumer. In such a case, FIG. 6E provides that a Retain Physical Check message code can be communicated to the store terminal for use in alerting the merchant. In addition, since consumers may have questions about the check return fees, a telephone number for customer service can be provided to the consumer by printing a customer service telephone number on the receipt. FIG. 6E also shows that the telephone number can be communicated to the consumer as part of the message format. It should be noted that different combinations of the message information shown in FIG. 6E could be communicated to the store terminal as parts of different transmissions from the host for the benefit of the store terminal. Thus, it should be understood that the message formatting and number of transmissions used can vary.

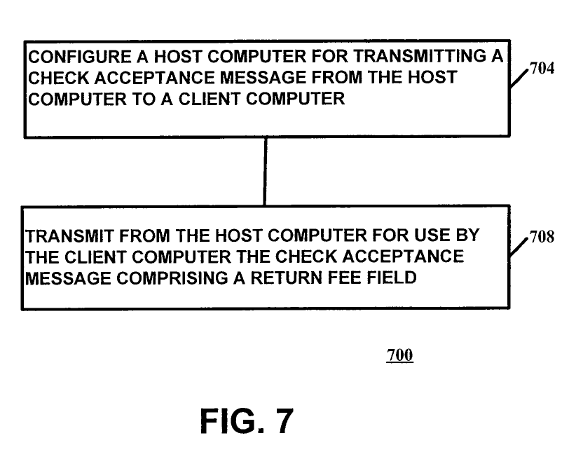

Referring now to FIG. 7, a flowchart 700 is shown that illustrates an embodiment of the invention. In FIG. 7, a host computer is configured for transmitting a check acceptance message from the host computer to the client computer, as shown in block 704. A check acceptance message is understood to mean a message returned by the host in response to an inquiry as to whether to accept a check. Thus, a check acceptance message could be sent in response to an inquiry by a store terminal as to whether to accept a check. A check acceptance message could be a single transmission or a sequence of transmissions. In block 708, the host computer transmits the check acceptance message comprising a return fee field so that the check acceptance can be used by the client computer. One example of a client computer is the in-store terminal in FIG. 4. Other examples are other terminals and processing platform computers that interface with the host for the purpose of conducting check acceptance.

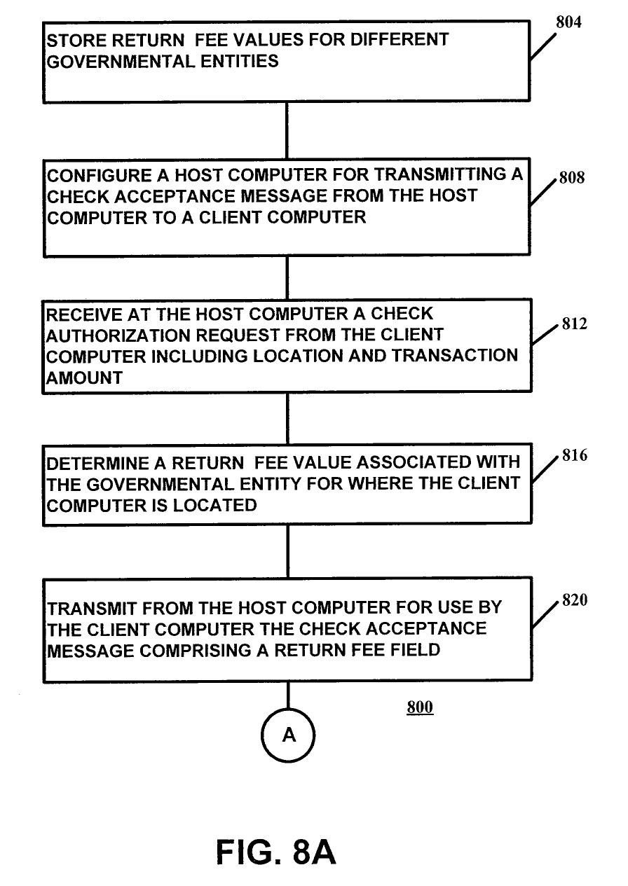

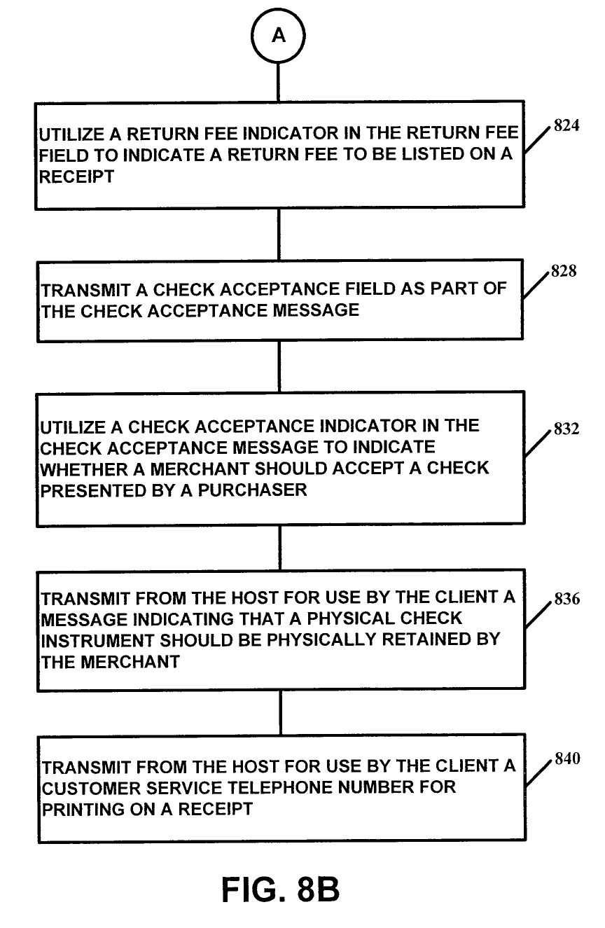

A more detailed embodiment can be seen in FIGS. 8A and 8B. FIGS. 8A and 8B illustrate a flow chart 800. In block 804, return fee information, such as return fee values, are stored for different governmental entities. For example, the check return fee values that apply to the different states in the United States of America can be stored as part of a database. Similarly, the check return fee values that apply to different countries in Europe can be stored as part of the database. In block 808, the host computer can be configured for transmitting a check acceptance message from the host computer to a client computer. Flow chart 800 illustrates in block 812 that the store terminal can send an authorization request from the client computer to the host computer. This authorization request can include the amount for the check that is to be processed as well as an identifier that indicates the location of the terminal. The identifier that indicates the location of the terminal allows the host to look up the appropriate return fee based on location of the terminal. The transaction amount or check amount allows the host to compute the return fee for those states that compute the return fee based on the amount of the transaction or check amount. Thus, block 816 illustrates that the return fee value is determined that is associated with the governmental entity for where the client computer is located. In block 820, the host computer transmits for use by the client computer the check acceptance message. This check acceptance message comprises at least a return fee field. One could for example use a return fee field to indicate both that the check had been accepted and the return fee value for the terminal. Alternatively, a zero value or negative value for the return fee field could be used to indicate that the check was not accepted. Block 824 illustrates that a return fee indicator can be used in the return fee field to indicate the return fee to be listed on the receipt. In addition, block 828 illustrates that a check acceptance field can be used as part of the message transmitted from the host to the client computer. As shown in block 832, a check acceptance indicator can be utilized in the check acceptance message to indicate whether the merchant should accept the check presented by the consumer purchaser. As shown by blocks 836 and 840, additional information can also be transmitted from the host to the client computer. For example, block 836 shows that a message indicating that the physical check instrument should be physically retained by the merchant can be used. Similarly, block 840 illustrates that a customer service telephone number can be transmitted from the host to the client computer for printing on the receipt. The customer service number can then be used by the consumer to inquire about the check processing or charges.

As noted above, the return fee database can be used not only to store flat fees for particular states or governmental entities but also to store notes for a particular state or entity. Thus, for example, some states in the United States of America apply a return check fee that increases with time. If the consumer pays off the fee on time, the fee does not increase. If the consumer does not pay off the fee in time, the fee can be increased—for example, to a predetermined maximum. This information cannot be readily conveyed without a written explanation. Thus, in accordance with one embodiment of the invention, this note information that is related to a particular state or entity can be stored and downloaded to a store terminal for printing on a receipt. By storing the data in a database accessible by the host, the processing system can keep the information up to date.

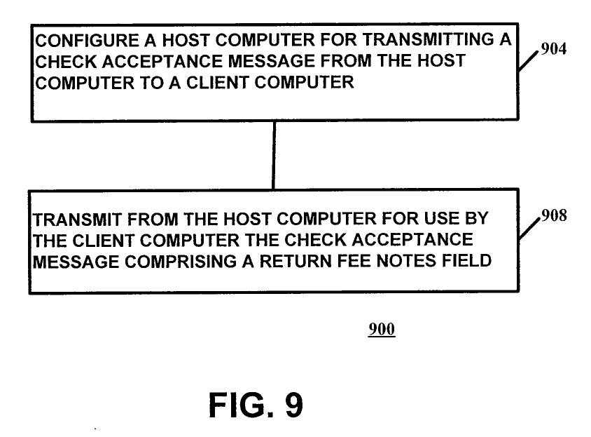

FIG. 9 illustrates a high level flow chart for implementing a fee note system in accordance with one embodiment of the invention. In flow chart 900, a host is configured for transmitting a check acceptance message from the host computer to a client computer. In block 908, the host transmits for use by the client computer a check acceptance message that comprises a return fee notes field.

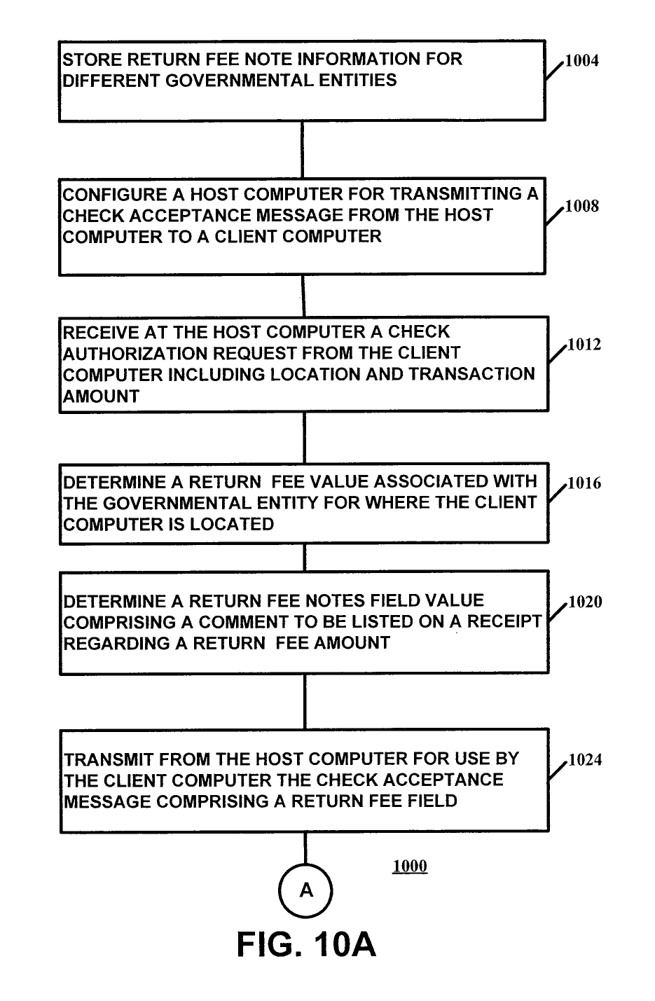

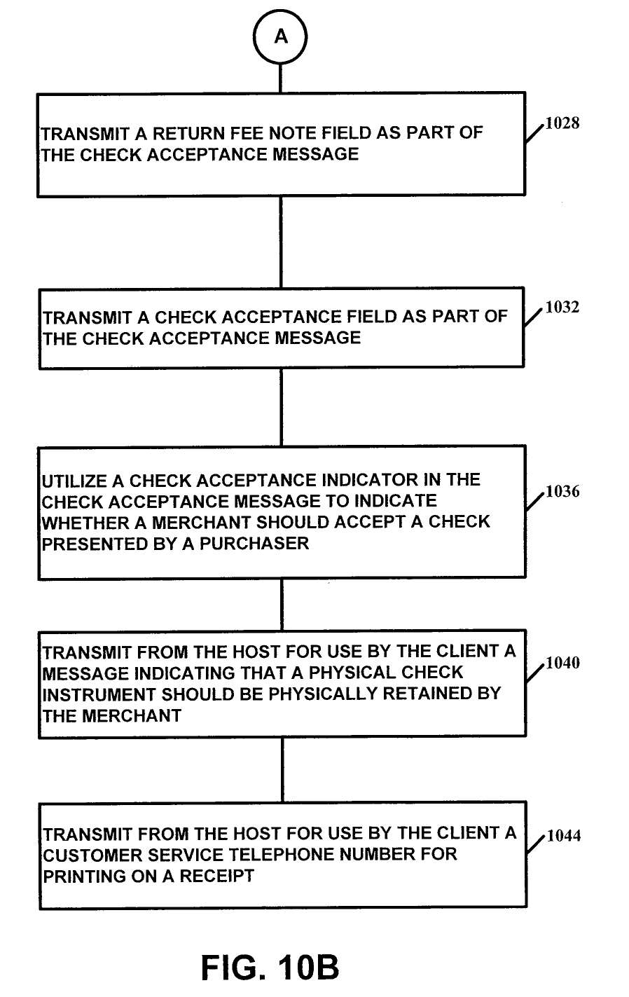

A more detailed example in accordance with one embodiment of the invention can be seen in FIGS. 10A and 10B. Namely, in FIG. 10A flow chart 1000 illustrates a method for communicating check return fee note information. In block 1004, the return fee note information for different governmental entities is stored. For example, return fee note information can be stored in a database with the actual return fee values that are associated with different governmental entities. In block 1008, a host computer is configured for transmitting a check acceptance message from the host computer to a client computer, such as a merchant's in-store terminal. In block 1012, the host computer receives an authorization request from the in-store terminal that includes, for example, the location of the in-store terminal and the check amount. In block 1016, the host determines from a database a return fee value associated with the governmental entity for where the in-store terminal is located. In block 1020, the host also can determine from a return fee notes field of the database a comment to be listed on the receipt along with the return fee value. The note can state for example that the return fee amount will incur interest if not paid off within 7 days or that the return fee amount will increase by $5.00 every 30 days up to a maximum of $50. Other examples could be utilized as well. In block 1024, the host computer transmits for use by the client computer (i.e., the in-store terminal) a check acceptance message that comprises a return fee field. Similarly, in block 1028 the host can transmit a return fee note field as part of the check acceptance message. In block 1032, the host can transmit a check acceptance field as part of the check acceptance message. In addition, in block 1036, a check acceptance indicator can be utilized as part of the check acceptance message to indicate whether a merchant should accept a check presented by a purchaser. In block 1040, the host may also transmit for use by the client computer a message indicating that the physical check instrument should be physically retained and processed by the merchant rather than using electronic capture. Finally, block 1044 shows that the host can transmit for use by the client a customer service telephone number for printing on the receipt.

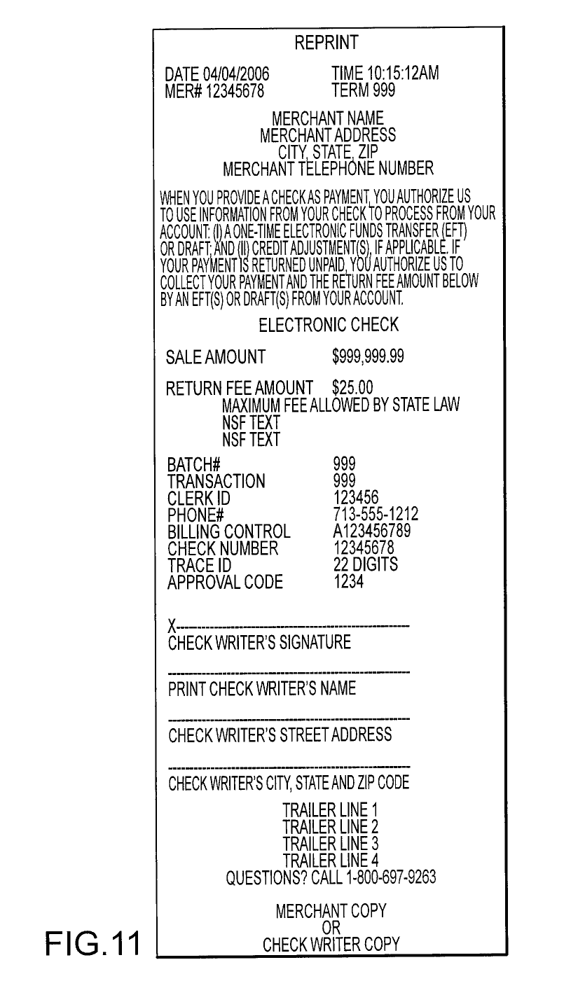

FIG. 11 illustrates an example of a receipt that can be generated by a store terminal in accordance with at least one embodiment of the invention. Namely, FIG. 11 illustrates a receipt that shows the return fee amount as $25.00 and two fields for return fee notes, labeled as NSF Text. These fields can be used if further explanation of the fee is desired. Also shown is a signature block for the customer to acknowledge agreement to the conditions.

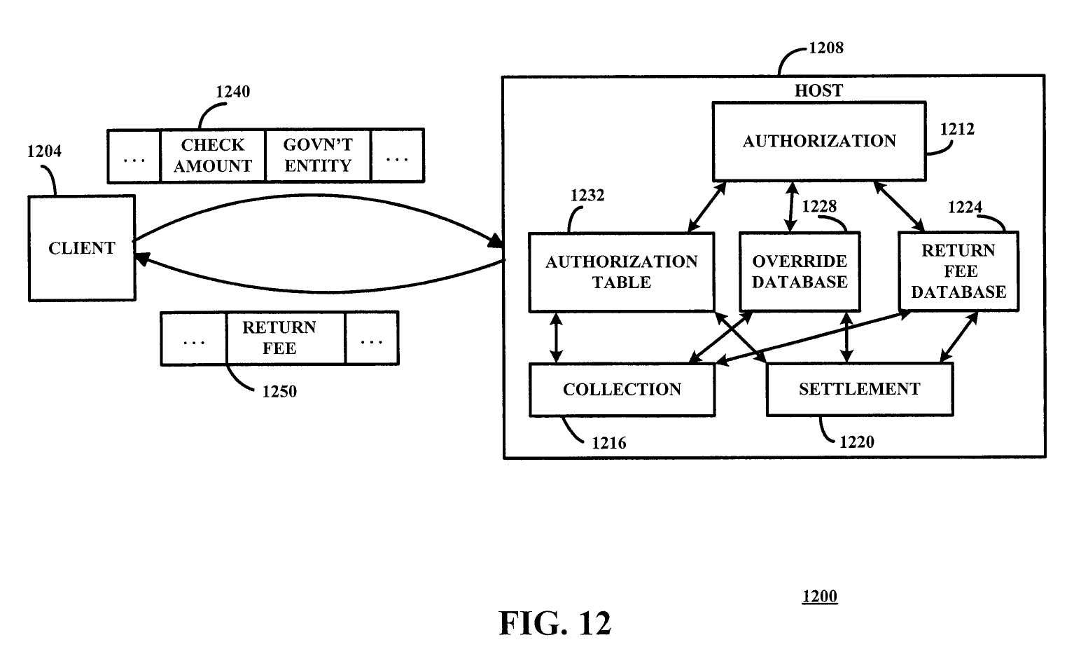

FIG. 12 illustrates an example of an electronic check processing system 1200 in accordance with one embodiment of the invention. A host system 1208 is shown coupled with a client system 1204. Communications between the host and client can take place across a public network, a private network, or via a direct connection. The host system is shown comprised of an authorization system 1212 for authorizing checks; a settlement system 1220 for settling the checks; and a collection system 1216 for collecting on checks that did not have sufficient funds at the time of settlement. The host system 1200 is also shown as having a return fee database 1224, an override database 1228, and an authorization table 1232.

The system can receive transaction requests, such as request 1240, and output a response to the transaction request, such as response 1250. For example, a client computer 1204, such as an in-store terminal, can issue a check authorization request that includes an amount of the check and a state where the transaction is taking place. The host can route the request to the authorization system. At the authorization system, a test can be made to determine if the consumer satisfies predetermined criteria for the check amount. If so, the check can be authorized.

A return fee can also be reported from the host to the client to allow the client to notify the consumer of the return fee for a check if the check is later returned for insufficient fees. The return fee can be determined in a variety of ways. For example, it is possible that some merchants may want the processing system to limit the return fee that is applied to an amount less than what would be allowable by the rules of the governmental entity. For example, if the state of New York allowed a return fee of up to $30, the merchant may prefer to limit the return fee to $20 in order to generate customer goodwill. Thus, a test may be made by checking with the override database 1228 to see if the merchant from which the check authorization request was received has an override value. If so, the override value can be output as the check return fee as part of message 1250 that is sent to the client.

Typically, it is expected that the return fee will be determined by using the return fee database 1224. Thus, the host can use the governmental entity information from the request message 1240 to look up a fee in the return fee database 1224. The return fee database may be a flat fee or a fee that is calculated according to a predetermined equation. Thus, the check amount that was sent as part of message 1240 can be used in the equation, if needed. In some instances, the fee determined through use of the return fee database can be compared to the fee determined from the override database—in such a case, the lower value can be output to the client.

An authorization table is also shown as part of host system 1208. The authorization table allows the host to maintain a record of return fees that are sent to the client computer. Thus, for example, a data record can be kept in the table that shows an identifier for the request, the check amount and government entity, an identifier for the response message, the return fee amount, and any return fee comments that are sent to the client computer—or a related combination of these fields. This record allows the settlement system and collection system to utilize the same return fee value and/or return fee comments that was used in notifying a consumer at the time of purchase. Thus, the collection system will not try and collect a return fee that is higher than what the consumer was told would be collected. This problem could occur in some instances when the return fee database or override database were unavailable for a request and a default value had to be reported to the client computer.

Alternatively, the collection system and/or settlement system could use the return fee database to recalculate the return fee, rather than using the authorization table.

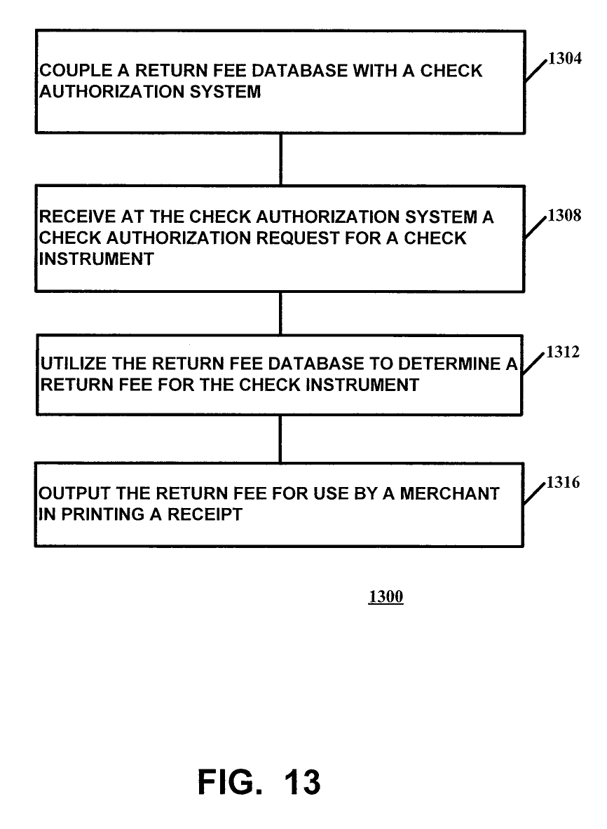

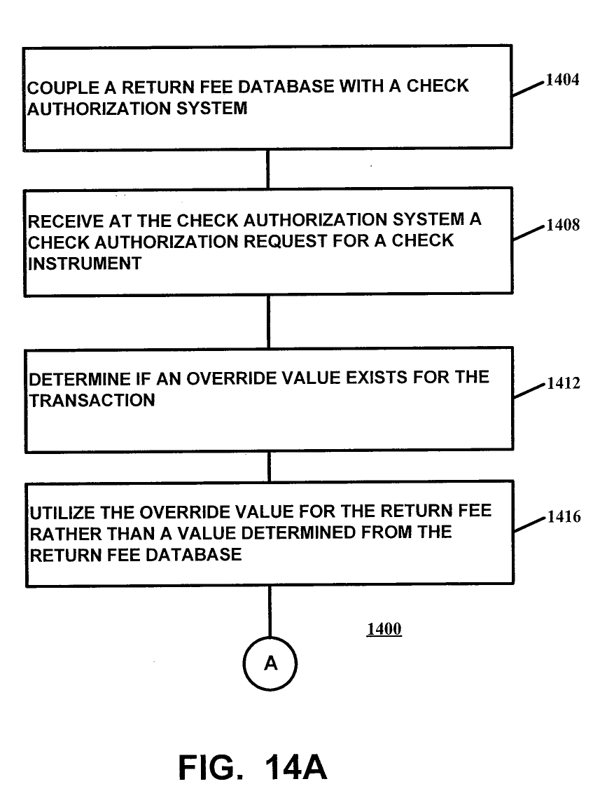

Examples of the system are shown in the following flow charts. FIG. 13 illustrates a high level flow chart 1300 for operation of an electronic processing system. In block 1304, a check authorization system is coupled with a return fee database. In block 1308, a check authorization request is received at the check authorization system for a check instrument being submitted to a merchant. The return fee database may be utilized to determine a return fee for the check instrument, as shown by block 1312. And, the return fee can be output for use by the merchant in printing a receipt, as shown in block 1316.

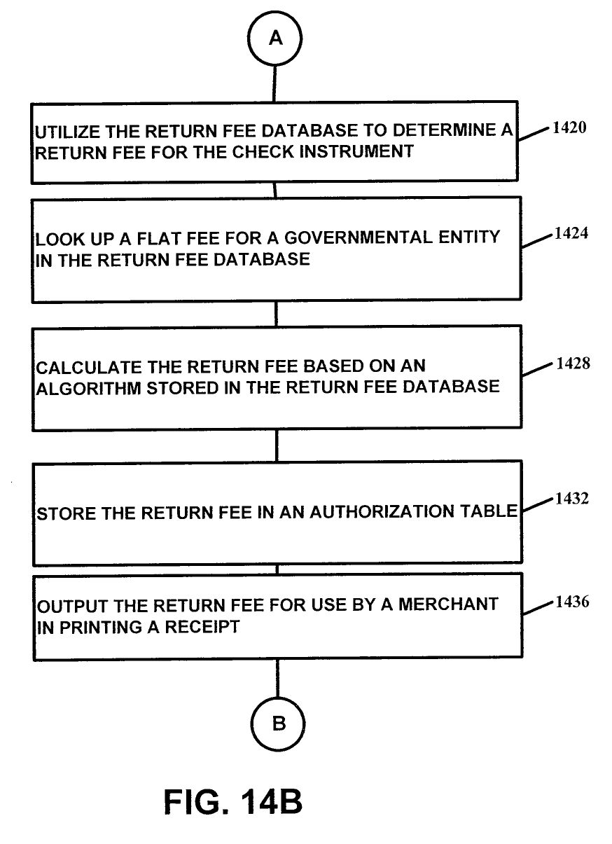

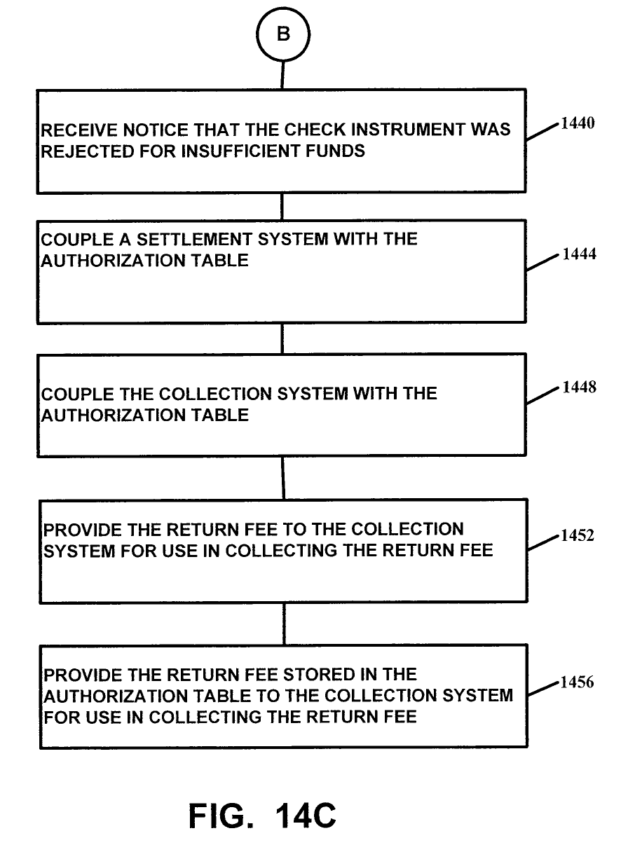

FIGS. 14A, 14B, and 14C illustrate another embodiment in flow chart 1400. In block 1404, a return fee database is coupled with a check authorization system. A check authorization request is received at the check authorization system for a check instrument tendered to a merchant, in block 1408. In block 1412, a determination is made as to whether an override value exists for the transaction. If so, the override value is used for the return fee rather than a value determined from the return fee database, as illustrated by block 1416. In block 1420, one can alternatively use the return fee database to determine a return fee for a check instrument. For example, block 1424 illustrates that this can be done by looking up a flat fee for a governmental entity, such as for the government of New York state in the United States of America. Similarly, where an equation is utilized, the return fee can be calculated based on the equation stored in the return fee database, as shown by block 1428. In block 1432, the return fee can be stored as part of an authorization table. The return fee can also be output for use by a merchant in printing a receipt, as shown by block 1436. In block 1440, the host can receive notice that the check instrument was rejected during settlement for insufficient funds. The settlement system can make additional settlement attempts and apply the check return fee. Alternatively, the collection system can attempt to collect the unpaid check and apply the check return fee. Thus, the settlement system can be coupled with the authorization system as shown in block 1444. This allows the settlement system to see the return fee that was used to notify the consumer at the time of purchase. In block 1448, the collection system can similarly be coupled with the authorization table. The return fee may thus be provided to the collection system for use in collecting the return fee as shown in block 1452 and one way of accomplishing this is by providing the return fee stored in the authorization table, as shown in block 1456.

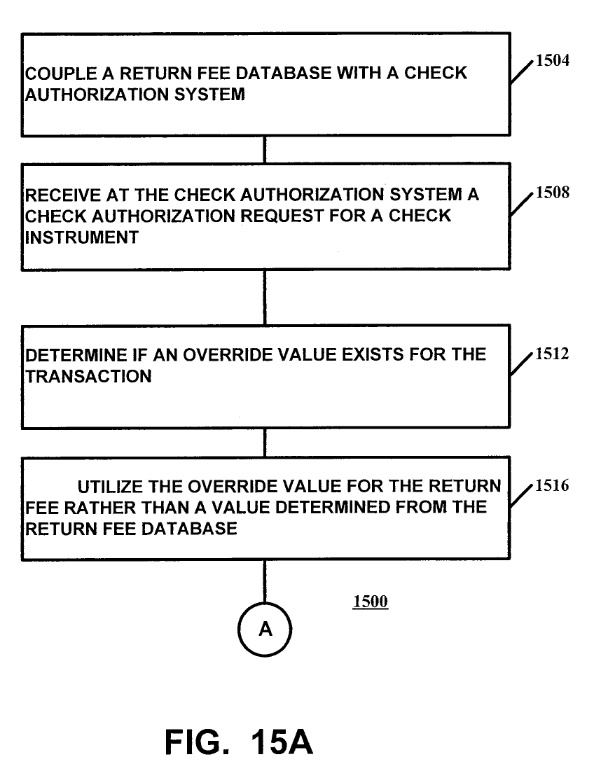

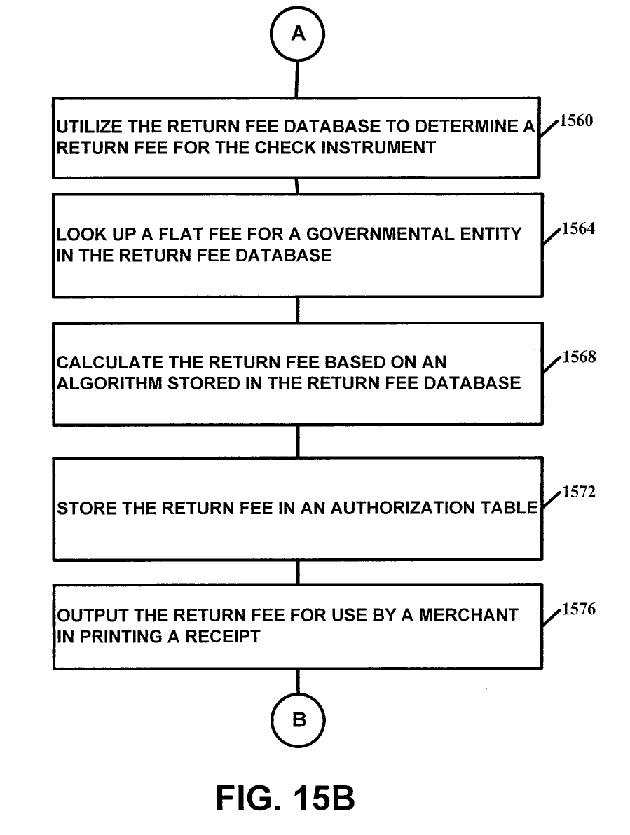

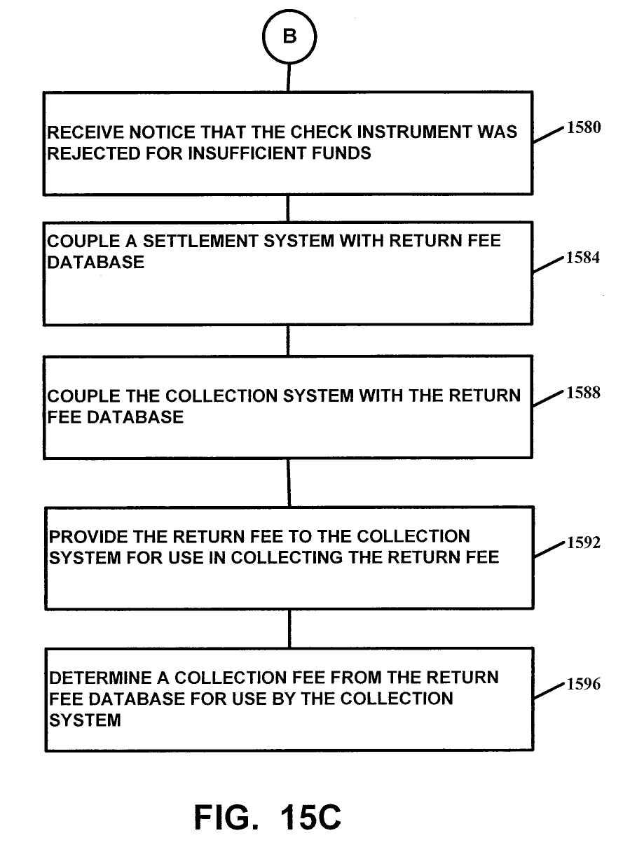

FIGS. 15A, 15B, and 15C illustrate another embodiment. In flow chart 1500, a return fee database is coupled with a check authorization system in block 1504. In block 1508, a check authorization request for a check instrument is received at the check authorization system. In block 1512, a determination is made to see if an override value exists for the transaction. In block 1516, one may utilize the override value for the return fee rather than a value determined from the return fee database. In block 1560, one may utilize the return fee database to determine a return fee for the check instrument. This can be accomplished as shown in block 1564 by looking up a flat fee in the return fee database or by calculating the return fee based upon a stored algorithm, as shown in block 1568. In block 1572, the return fee may be stored in an authorization table and output for use by a merchant as shown by block 1576. Block 1580 indicates that a notice can be received indicating that the check was rejected for insufficient funds in the checking account. Blocks 1584 and 1588 indicate that the settlement system and collection system may be coupled with the return fee database. Furthermore, block 1592 illustrates that the return fee may be provided to the collection system for use in collecting the return fee. For example, this may be accomplished by determining a collection fee from the return fee database for use by the collection system, as shown by block 1596. The use of the phrase collection fee is utilized to distinguish a fee calculated from the return fee database upon prompting by the collection system as opposed to the return fee generated for reporting out to the client computer.

While various embodiments of the invention have been described as methods or apparatus for implementing the invention, it should be understood that the invention can be implemented through code coupled to a computer, e.g., code resident on a computer or accessible by the computer. For example, software and databases could be utilized to implement many of the methods discussed above. Thus, in addition to embodiments where the invention is accomplished by hardware, it is also noted that these embodiments can be accomplished through the use of an article of manufacture comprised of a computer usable medium having a computer readable program code embodied therein, which causes the enablement of the functions disclosed in this description. Therefore, it is desired that embodiments of the invention also be considered protected by this patent in their program code means as well. Furthermore, the embodiments of the invention may be embodied as code stored in a computer-readable memory of virtually any kind including, without limitation, RAM, ROM, magnetic media, optical media, or magneto-optical media. Even more generally, the embodiments of the invention could be implemented in software, or in hardware, or any combination thereof including, but not limited to, software running on a general purpose processor, microcode, PLAs, or ASICs.

It is also envisioned that embodiments of the invention could be accomplished as computer signals embodied in a carrier wave, as well as signals (e.g., electrical and optical) propagated through a transmission medium. Thus, the various information discussed above could be formatted in a structure, such as a data structure, and transmitted as an electrical signal through a transmission medium or stored on a computer readable medium.

It is also noted that many of the structures, materials, and acts recited herein can be recited as means for performing a function or steps for performing a function. Therefore, it should be understood that such language is entitled to cover all such structures, materials, or acts disclosed within this specification and their equivalents, including the matter incorporated by reference.

It is thought that the apparatuses and methods of the embodiments of the present invention and its attendant advantages will be understood from this specification. While the above is a complete description of specific embodiments of the invention, the above description should not be taken as limiting the scope of the invention as defined by the claims.

What is claimed is:

1. A method of processing checks in a system comprising a check authorization system and a collection system, said method comprising:
coupling a return fee database with said check authorization system;
receiving at said check authorization system a check authorization request for a check instrument;
utilizing said return fee database to determine a return fee for said check instrument;
outputting said return fee for use by a merchant in printing a receipt.

2. The method as claimed in claim 1 and further comprising:
receiving notice that said check instrument was rejected for insufficient funds.

3. The method as claimed in claim 2 and further comprising:
providing said return fee to said collection system for use in collecting said return fee.

4. The method as claimed in claim 1 and further comprising:
storing said return fee in an authorization table.

5. The method as claimed in claim 4 and further comprising:
coupling said collection system with said authorization table.

6. The method as claimed in claim 5 and further comprising:
receiving notice that said check instrument was rejected for insufficient funds;
providing said return fee stored in said authorization table to said collection system for use in collecting said return fee.

7. The method as claimed in claim 4 and further comprising:
coupling a settlement system with said authorization table.

8. The method as claimed in claim 4 and further comprising:
coupling said collection system with said authorization table; and
coupling a settlement system with said authorization table.

9. The method as claimed in claim 8 and further comprising:
receiving notice that said check instrument was rejected for insufficient funds;
providing said return fee stored in said authorization table to said collection system for use in collecting said return fee.

10. The method as claimed in claim 1 and further comprising:
coupling said collection system with said return fee database.

11. The method as claimed in claim 10 and further comprising:
determining a collection fee from said return fee database for use by said collection system.

12. The method as claimed in claim 1 and further comprising:
coupling a settlement system with said return fee database.

13. The method as claimed in claim 1 and further comprising:
coupling said collection system with said return fee database; and
coupling a settlement system with said return fee database.

14. The method as claimed in claim 13 and further comprising:
determining a collection fee from said return fee database for use by said collection system.

15. The method as claimed in claim 1 wherein said utilizing said return fee database to determine a return fee for said check transaction comprises:
determining if an override value exists for said transaction; and
utilizing said override value for said return fee rather than a value determined from said return fee database.

16. The method as claimed in claim 15 wherein said determining if said override value exists comprises:
determining if a transaction applies to a merchant associated with a check return fee override value.

17. The method as claimed in claim 1 wherein said utilizing said return fee database to determine said return fee comprises:
looking up a flat fee for a governmental entity in said return fee database.

18. The method as claimed in claim 1 wherein said utilizing said return fee database to determine said return fee comprises:
calculating said return fee based on an algorithm stored in said return fee database.

19. The method as claimed in claim 1 and further comprising:
settling said check instrument.

20. The method as claimed in claim 1 and further comprising:
settling said check instrument;
receiving notice that said check instrument was rejected for insufficient funds;
providing said return fee to said collection system for use in collecting said return fee.
